(19) United States
(12) Patent Application Publication
(10) Pub. No.: US 2021/0132998 A1
(43) Pub. Date: May 6, 2021

(54) SEMICONDUCTOR DEVICE AND CONTROL METHOD THEREOF

(71) Applicant: RENESAS ELECTRONICS CORPORATION, Tokyo (JP)

(72) Inventors: Takuro UCHIDA, Tokyo (JP); Atsushi FUJIOKA, Tokyo (JP)

(21) Appl. No.: 17/027,974

(22) Filed: Sep. 22, 2020

(30) Foreign Application Priority Data
Nov. 3, 2019 (JP) 2019-200349

(51) Int. Cl. G06F 9/50; G06F 9/52; G06F 13/362; G06F 11/34; G06F 11/30

(52) U.S. Cl. CPC G06F 9/5016; G06F 9/526; G06F 11/3075; G06F 11/3476; G06F 13/362

(57) ABSTRACT

A semiconductor device performs exclusive control between a first processor element and a second processor element using a spinlock. Each of the first processor element and the second processor element includes a processing unit and a storage unit. The processing unit generates first spinlock trace information and second spinlock trace information, determines, based on a first spinlock operation state after the first spinlock trace information is generated and the second spinlock trace information, a second spinlock operation state after the second spinlock trace information is generated, and generates an output control signal for determining whether to store the second spinlock trace information in the storage unit in accordance with the second spinlock operation state.

### CROSS-REFERENCE TO RELATED APPLICATIONS

The disclosure of Japanese Patent Application No. 2019-200349 filed on Nov. 3, 2019 including the specification, drawings and abstract is incorporated herein by reference in its entirety.

### BACKGROUND

This disclosure relates to a semiconductor device and a control method of the semiconductor device.

### The Background of the Invention

A technique of a spinlock is generally used as exclusive control between processor elements (PEs) when developing applications that utilize an operating system (real time operating system) that is controlled in real time by multiple cores (many cores).

There are disclosed techniques listed below. [Patent Document 1] Japanese Unexamined Patent Application Publication No. 2008-27305

For example, Patent Document 1 discloses a spinlock.

In a spinlock, when a waiting time for acquiring a lock variable occurs, the PE is in a state (busy wait) in which it is difficult for the PE to respond to other processing. This affects the throughput of the entire system. Therefore, in order to optimize the application, it is necessary to measure the lock waiting time. Hereinafter, “waiting for acquiring a lock variable” is also referred to as “lock waiting”.

### SUMMARY

In order to measure the lock waiting time, when the event such as starting acquiring the lock variable occurs, the PE outputs information for tracing the event and the time. Hereinafter, the information is referred to as “spinlock trace information” or simply “trace information”. The lock waiting time can be measured by the difference between the time at which acquiring the lock variable starts and the time at which acquiring the lock variable succeeds.

However, each time the PE fails to acquire the lock variable and enters the lock waiting state, the PE outputs the trace information for the lock waiting start. That is, a lock waiting occurs, and the trace information of the lock waiting start is repeatedly output for the number of times the loop processing by the busy wait is executed. At this time, a large amount of storage space is required to store a large number of trace information. If sufficient storage space cannot be allocated, the trace information required by the developer of the application may not be acquired. This problem becomes more pronounced when there are two or more types of lock variables and a spinlock configuration in which multiple lock variables are acquired.

Other objects and novel features will be apparent from the description of this specification and the accompanying drawings.

### Means of Solving the Problems

A semiconductor device according to one embodiment performs exclusive control between a first processor element and a second processor element using a spinlock. Each of the first processor element and the second processor element includes a processing unit and a storage unit. The processing unit generates first spinlock trace information and second spinlock trace information, determines, based on a first spinlock operation state after the first spinlock trace information is generated and the second spinlock trace information, a second spinlock operation state after the second spinlock trace information is generated, and generates an output control signal for determining whether to store the second spinlock trace information in the storage unit in accordance with the second spinlock operation state.

According to one embodiment, by discarding trace information unnecessary for measuring the lock waiting time, the semiconductor device can appropriately acquire trace information required by the developer of the application.

### BRIEF DESCRIPTION OF THE DRAWINGS

FIG. 1 is a block diagram showing an example of a hardware configuration of a semiconductor device according to a first embodiment.

FIG. 2 is a block diagram showing an example of functional blocks of the semiconductor device according to the first embodiment.

FIG. 3 is a configuration diagram showing an example of a configuration of trace information.

FIG. 4 is a flowchart showing an example of a spinlock operation of the semiconductor device.

FIG. 5 is an explanatory diagram for explaining an example of input/output of trace information.

FIG. 6 is a state transition diagram showing an example of state transitions of a spinlock operation.

FIG. 7 is a table for explaining changes in lock waiting variable information and changes in an output control signal.

FIG. 8 is a block diagram showing an example of functional blocks of a semiconductor device according to a second embodiment.

FIG. 9 is a block diagram showing an example of a hardware configuration of a debug system according to a third embodiment.

FIG. 10 is a block diagram showing an example of functional blocks of an emulator according to the third embodiment.

### DETAILED DESCRIPTION

Hereinafter, embodiments of the present will be described in detail with reference to the drawings. In the specification and the drawings, the same or corresponding components are denoted by the same reference numerals, and a repetitive description thereof is omitted. In the drawings, for convenience of description, the configuration may be omitted or simplified.

### First Embodiment

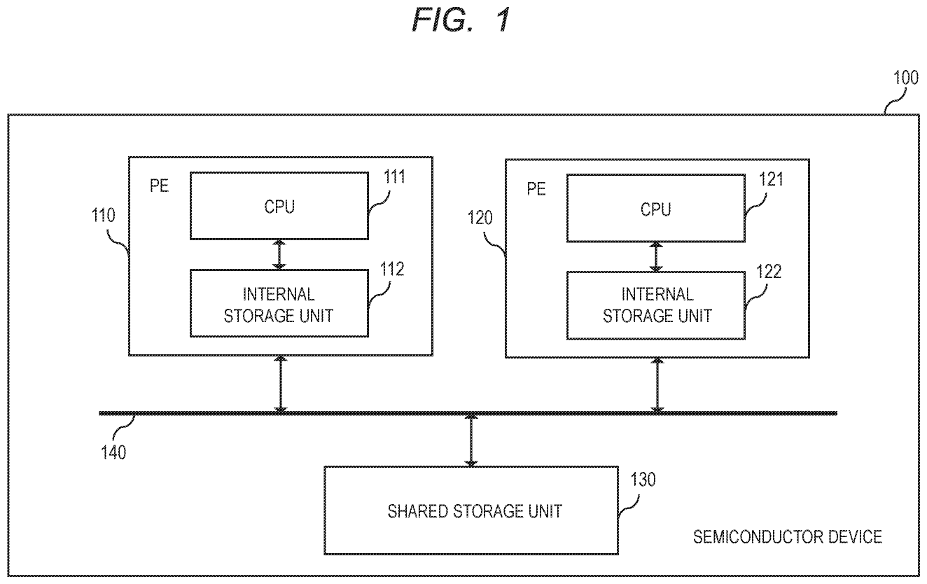

FIG. 1 is a block diagram showing an example of a hardware configuration of a semiconductor device 100 according to a first embodiment. As shown in FIG. 1, the semiconductor device 100 includes a PE 110 as a first processor element, a PE 120 as a second processor element, a shared storage unit 130, and a bus 140. That is, the semiconductor device 100 configures a multiple core system including the PE 110 and the PE 120. Exclusive control between the PE 110 and the PE 120 is performed using a spinlock.

The PE 110 and the PE 120 are connected to the shared storage unit 130 via the bus 140. The shared storage unit 130 stores lock variables, and during the spinlock operation, the PE 110 and the PE 120 acquire and release the lock variables.

The PE 110 includes a Central Processing Unit (CPU) 111 as a processing unit and an internal storage unit 112. The internal storage unit 112 stores programs such as a real time operating system and a trace output control function. The CPU 111 is a processor that reads the program from the internal storage unit 112 and executes the read program. The program may be stored in the shared storage unit 130. In this case, the CPU 111 reads the program from the shared storage unit 130 and executes the read program.

The PE 120 includes a CPU 121 and an internal storage unit 122. The PE 120 has the same configuration and function as the PE 110.

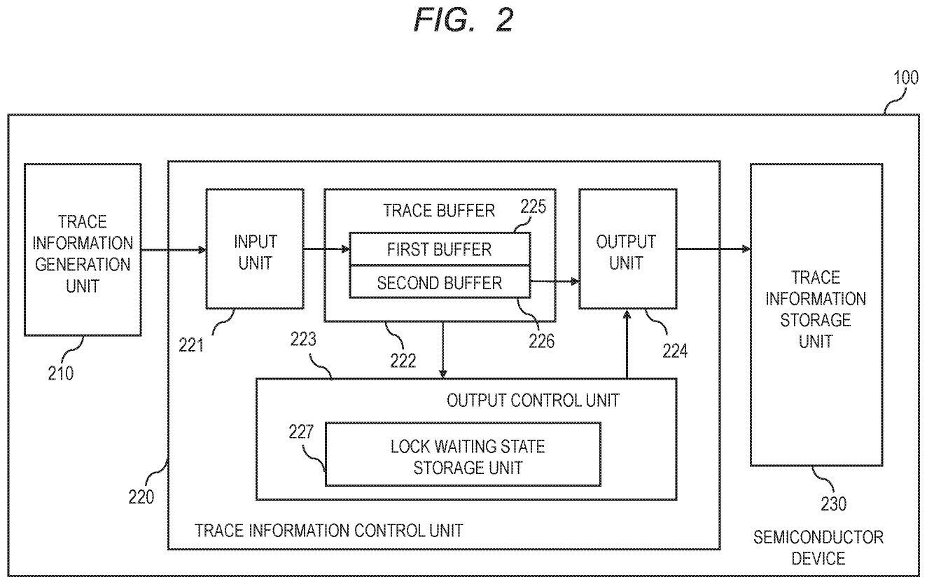

FIG. 2 is a block diagram showing an example of functional blocks of the semiconductor device 100 according to the first embodiment. Here, a function of a trace information control unit will be mainly described focusing on the PE 110, but the PE 120 also has the same function as that shown in FIG. 2.

As shown in FIG. 2, the semiconductor device 100 includes a trace information generation unit 210, a trace information control unit 220, and a trace information storage unit 230. The functions of the trace information generation unit 210 and the trace information control unit 220 can be realized by the CPU 111 executing the program stored in the internal storage unit 112. The trace information storage unit 230 may be configured by a part of an area of the internal storage unit 112.

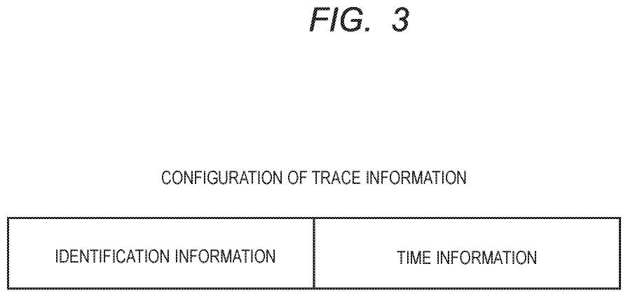

The trace information generation unit 210 generates trace information at the timing of starting acquiring the lock variable, the timing of succeeding in acquiring the lock variable, and the timing of failing to acquire the lock variable (i.e., the timing of the lock waiting start) by the PE 110. FIG. 3 is a configuration diagram showing an example of a configuration of trace information. As shown in FIG. 3, the trace information includes identification information and time information. The identification information indicates the event that occurred, such as succeeding in acquiring the lock variable. The time information indicates the occurrence time of the event that occurred.

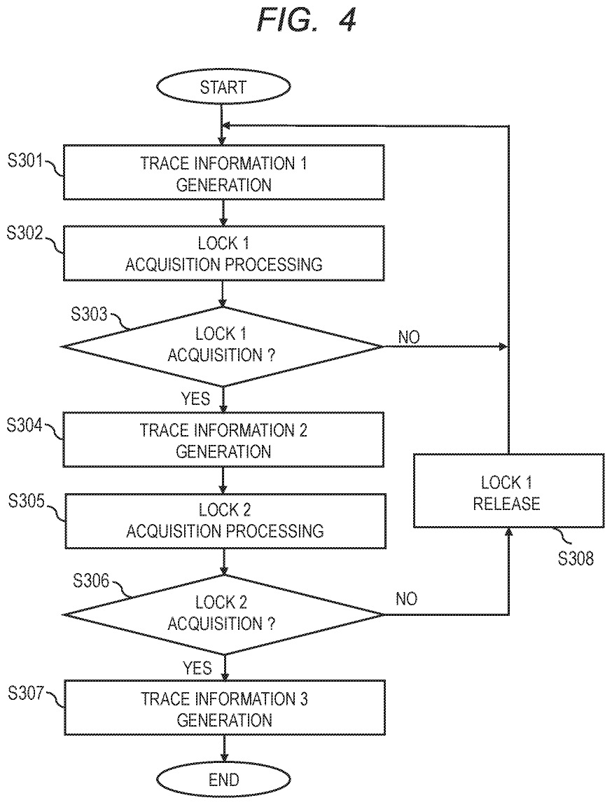

In addition, the trace information generated by the trace information generation unit 210 will be described with reference to FIG. 4. FIG. 4 is a flowchart showing an example of a spinlock operation when the semiconductor device 100 includes a spinlock configuration having two types of lock variables (lock variable 1 and lock variable 2).

As shown in FIG. 4, when the process of acquiring the lock variable is started, first, in a step S301, the trace information generation unit 210 generates trace information 1 as a first spinlock trace information.

In a step S302, the PE 110 accesses the shared storage unit 130 to acquire the lock variable 1.

In a step S303, it is determined whether the lock variable 1 has been acquired by the PE 110. If the lock variable 1 is acquired by the PE 110 (YES in the step S303), the process proceeds to a step S304. On the other hand, if the lock variable 1 is not acquired by the PE 110 (NO in the step S303), the process returns to the step S301. In this case, the trace information generation unit 210 generates the trace information 1 again.

In the step S304, the trace information generation unit 210 generates trace information 2 as a second spinlock trace information.

In a step S305, the PE 110 accesses the shared storage unit 130 to acquire the lock variable 2.

In a step S306, it is determined whether the lock variable 2 has been acquired by the PE 110. If the lock variable 2 is acquired by the PE 110 (YES in the step S306), the process proceeds to a step S307. On the other hand, when the lock variable 2 is not acquired by the PE 110 (NO in the step S306), the process proceeds to a step S308.

In the step S307, the trace information generation unit 210 generates trace information 3, and the spinlock operation ends.

In the step S308, the PE 110 accesses the shared storage unit 130 and releases the lock variable 1. The reason why the acquired lock variable 1 is released is to prevent a decrease in throughput of another PE, e.g., PE 120, caused by continuing to occupy the lock variable. After the process of releasing the lock variable 1 is performed, the process returns to the step S301, and the trace information generation unit 210 generates the trace information 1 again.

As described above, the trace information generation unit 210 generates the trace information 1 at the timing of starting acquiring the lock variable or the timing of the lock waiting start (step S301). Further, the trace information generation unit 210 generates the trace information 2 and the trace information 3 at the timing of succeeding in acquiring the lock variables (step S304 and step S307). When the PE 110 fails to acquire the lock variable and the loop processing by the busy wait is executed (NO in the step S303 and NO in the step S306), the trace information 1 and the trace information 2 are generated by the number of times the loop processing is executed (step S301 and step S304).

Returning to FIG. 2, the description of the functional blocks of the semiconductor device 100 will be continued. The trace information control unit 220 includes an input unit 221, a trace buffer 222, an output control unit 223, and an output unit 224.

The input unit 221 is connected to the trace information generation unit 210 and receives the trace information output from the trace information generation unit 210. In addition, the input unit 221 is connected to the trace buffer 222, and outputs the trace information received from the trace information generation unit 210 to the trace buffer 222.

The trace buffer 222 has two-stage buffers (first buffer 225 and second buffer 226). The first buffer 225 and the second buffer 226 sequentially store continuous trace information by First-in First-out (FIFO). Further, the trace buffer 222 is connected to the output unit 224 and outputs the trace information to the output unit 224, by FIFO.

The trace buffer 222 may be configured by an area (e.g., register) for temporarily storing data in the CPU 111 or may be configured by a part of an area of the trace information storage unit 230.

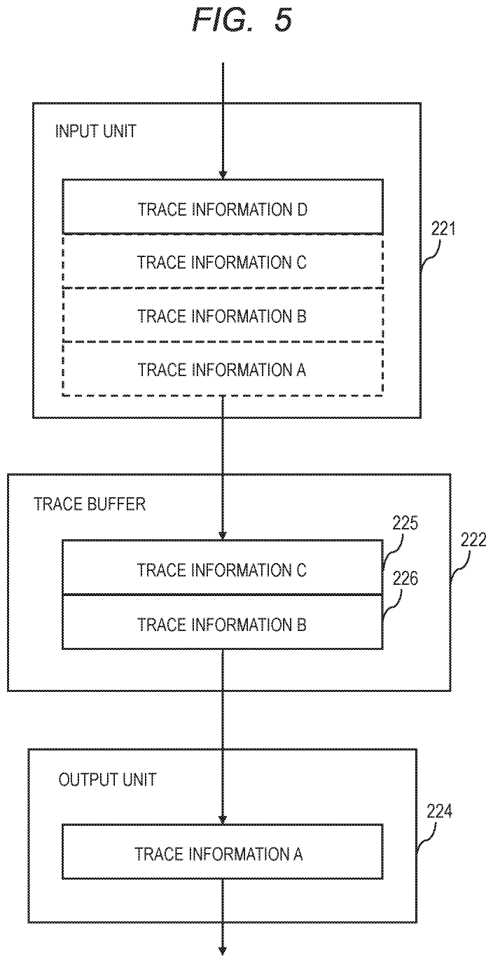

The operation of the trace buffer 222 will now be described in detail with reference to FIG. 5. FIG. 5 is an explanatory diagram for explaining an example of input/output of trace information. As shown in FIG. 5, the input unit 221 receives trace information A, trace information B, trace information C, and trace information D in this order, and outputs the received trace information to the trace buffer 222 in the same order.

The trace buffer 222 sequentially stores the received trace information by FIFO. At the timing shown in FIG. 5, the trace information C is stored in the first buffer 225, and the trace information B is stored in the second buffer 226. The trace information A initially received by the trace buffer 222 is output from the second buffer 226 to the output unit 224.

Thus, the first buffer 225 operates to store the trace information (trace information C, second spinlock trace information) that follows the trace information (trace information B, first spinlock trace information) stored in the second buffer 226.

Returning to FIG. 2, the description of the functional blocks of the semiconductor device 100 will be continued. The output control unit 223 is connected to the trace buffer 222. The output control unit 223 acquires the trace information stored in the trace buffer 222.

Further, the output control unit 223 includes a lock waiting state storage unit 227. The output control unit 223 determines the spinlock operation state after the trace information stored in the first buffer 225 is generated and stores the determined spinlock operation state as lock waiting variable information in the lock waiting state storage unit 227. That is, by referring to the lock waiting variable information stored in the lock waiting state storage unit 227, the spinlock operation state after the trace information stored in the first buffer 225 is generated can be specified.

For example, when the spinlock operation state is the waiting state for acquiring the lock variable, the output control unit 223 stores the lock waiting variable information indicating that the spinlock operation state is the waiting state for acquiring the lock variable in the lock waiting state storage unit 227. On the other hand, when the spinlock operation state is not the waiting state for acquiring the lock variable, the output control unit 223 stores the lock waiting variable information indicating that the spinlock operation state is not the waiting state for acquiring the lock variable in the lock waiting state storage unit 227. The lock waiting variable information indicating that the spinlock operation state is not the waiting state for acquiring the lock variable may be indicated by not storing the lock waiting variable information in the lock waiting state storage unit 227.

As shown in FIG. 4, in the case of the spinlock configuration having the lock variable 1 and the lock variable 2, there are two kinds of waiting states of the lock variable. When the spinlock operation state is the waiting state for acquiring the lock variable 1, the output control unit 233 stores the lock waiting variable information indicating that the spinlock operation state is the waiting state for acquiring the lock variable 1 in the lock waiting state storage unit 227. In addition, when the spinlock operation state is the waiting state for acquiring the lock variable 2, the output control unit 233 stores the lock waiting variable information indicating that the waiting state for acquiring the lock variable 2 in the lock waiting state storage unit 227.

Each time new trace information is stored in the first buffer 225, the output control unit 223 determines the spinlock operation state after the new trace information is generated based on the lock waiting variable information stored in the lock waiting state storage unit 227 and the new trace information. In other words, the output control unit 223 determines the spinlock operation state as the second spinlock operation state after the following trace information is generated, based on the spinlock operation state as the first spinlock operation state after the trace information (preceding trace information, first spinlock trace information) stored in the second buffer 226 is generated and the trace information (following trace information, second spinlock trace information) stored in the first buffer 225.

As described above, each time new trace information is stored in the first buffer 225, the output control unit 223 determines the spinlock operation state and updates the lock waiting variable information stored in the lock waiting state storage unit 227.

When the spinlock operation is started, the lock waiting variable information is not stored in the lock waiting state storage unit 227. In this case, the output control unit 223 determines that the spinlock operation state is not the waiting state for acquiring the lock variable, and stores a lock waiting variable information indicating that the spinlock operation state is not the waiting state for acquiring the lock variable in the lock waiting state storage unit 227.

The output control unit 223 generates a signal (output control signal) indicating whether to store the trace information stored in the first buffer 225 in the trace information storage unit 230 according to the spinlock operation state after the trace information stored in the first buffer 225 is generated. That is, the output control unit 223 generates the output control signal indicating whether to store the following trace information (second spinlock trace information) in the trace information storage unit 230, based on the spinlock operation state as the first spinlock operation state after the trace information (preceding trace information, first spinlock trace information) stored in the second buffer 226 is generated, and the trace information (following trace information, second spinlock trace information) stored in the first buffer 225.

The lock waiting state storage unit 227 may be configured by an area (for example, register) for temporarily storing data in the CPU 111 or may be configured by a part of an area of the trace information storage unit 230.

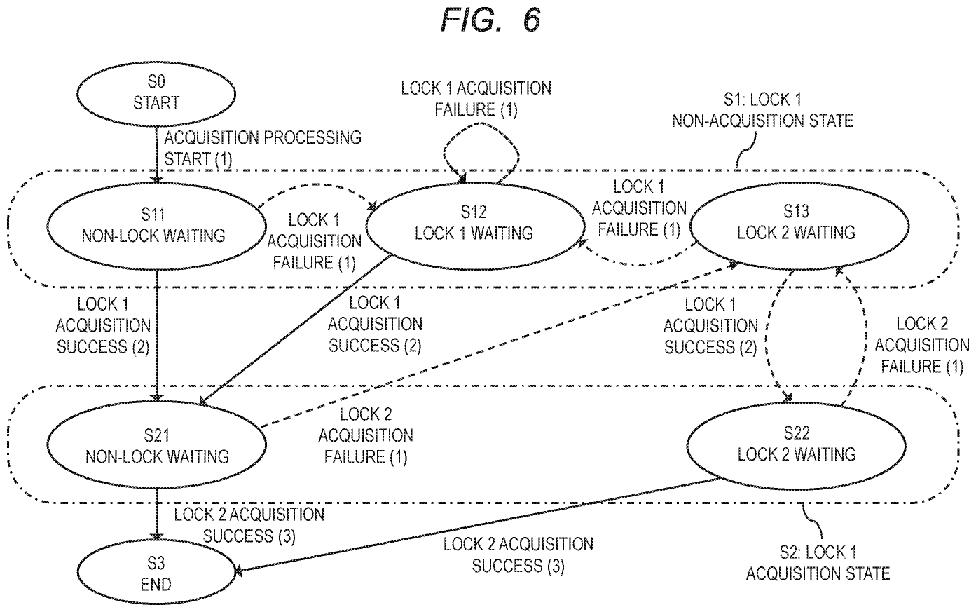

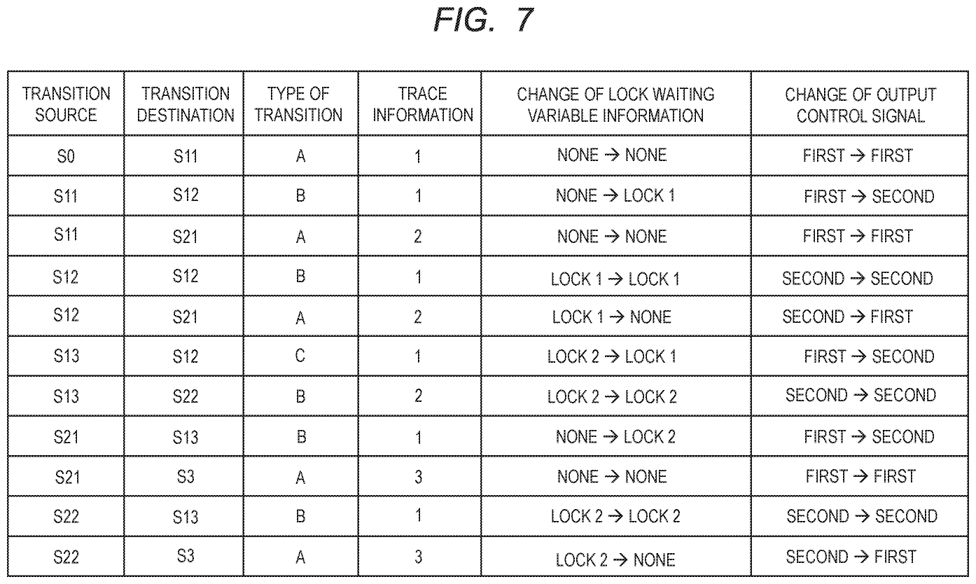

Here, with reference to FIGS. 6 and 7, the operation of the output control unit 223 will be described in detail. FIG. 6 is a state transition diagram showing an example of state transitions of the spinlock operation. Incidentally, FIG. 6 corresponds to the case where the semiconductor device 100 includes the configuration of the spinlock having the lock variable 1 and the lock variable 2 in the same manner as in FIG. 4.

As shown in FIG. 6, when focusing on acquiring the lock variable, the spinlock operation state is divided into four operation states (state S0, state S1, state S2 and state S3). The state S0 indicates the start state of the spinlock operation and corresponds to the state prior to the PE 110 starting the process of acquiring the lock variable.

The state S1 indicates a lock 1 non-acquisition state in which the PE 110 has not acquired the lock variable 1. The state S1 is further divided into three states (state S11, state S12, and state S13) according to the lock waiting state. The state S11 indicates the lock 1 non-acquisition state and a non-lock waiting state. The non-lock waiting state corresponds to a state in which the PE 110 has not failed to acquire the lock variable.

The state S12 indicates the lock 1 non-acquisition state and a lock 1 waiting state. The lock 1 waiting state corresponds to a state in which the PE 110 failed to acquire the lock variable 1. The state S13 indicates the lock 1 non-acquisition state and a lock 2 waiting state. The lock 2 waiting state corresponds to a state in which the PE 110 failed to acquire the lock variable 2.

The state S2 indicates a lock 1 acquisition state in which the PE 110 has acquired the lock variable 1. That is, the state S2 corresponds to a state in which the PE 110 has successfully acquired the lock variable 1 but has not acquired the lock variable 2.

The state S2 is further divided into two states (state S21 and state S22) according to the lock waiting state. The state S21 indicates the lock 1 acquisition state and the non-lock waiting state. The state S22 indicates the lock 1 acquisition state and the lock 2 waiting state. Since the above-described state S13 is a state in which transition has been made from the state S21 or the state S22, the state S13 can be expressed as a state in which the acquisition of the lock variable 2 has failed after the acquisition of the lock variable 1 has succeeded.

The state S3 indicates an end state of the spinlock operation. That is, the state S3 corresponds to a state in which the PE 110 successfully acquires the lock variable 1 and the lock variable 2.

As shown in FIG. 6, the state transition occurs in accordance with each event of the start of the lock variable acquisition processing, the success of the lock variable acquisition, and the failure of the lock variable acquisition. As described with reference to FIG. 4, the trace information generation unit 210 generates the trace information in accordance with the state transition.

In FIG. 6, a parenthesized number is attached to an event when a state transition occurs. This number corresponds to the output of the trace information shown in FIG. 4. For example, “(1)” is attached to the event of the state transition from the state S0 to the state S11 (the start of the lock variable acquisition processing). This means that when the state transition from the state S0 to the state S11 occurs, the trace information 1 is generated from the trace information generation unit 210.

The output control unit 223 analyzes the trace information stored in the first buffer 225 at the timing when the trace information is stored in the first buffer 225. The analysis is performed by confirming the identification information included in the trace information.

Based on the trace information stored in the first buffer 225 and the lock waiting variable information stored in the lock waiting state storage unit 227, the output control unit 223 can determine whether the trace information stored in the first buffer 225 is the information output corresponding to any of the state transitions shown in FIG. 6. In addition, based on the trace information stored in the first buffer 225 and the lock waiting variable information stored in the lock waiting state storage unit 227, the output control unit 223 can determine the spinlock operation state after the trace information stored in the first buffer 225 is generated.

The output control unit 223 stores the lock waiting variable information in the lock waiting state storage unit 227 according to the spinlock operation state shown in FIG. 6. For example, when the PE 110 is in the lock 1 waiting state (state S12), the output control unit 223 stores the lock waiting variable information indicating that the spinlock operation state is the lock waiting state of the lock variable 1 in the lock waiting state storage unit 227.

Similarly, when the PE 110 is in the lock 2 waiting state (state S13 and state S22), the output control unit 223 stores the lock waiting variable information indicating that the spinlock operation state is the lock waiting state of the lock variable 2 in the lock waiting state storage unit 227. When the PE 110 is in the non-lock waiting state (state S11 and state S21), the output control unit 223 stores the lock waiting variable information indicating that the spinlock operation state is not the waiting state for acquiring the lock variable in the lock waiting state storage unit 227.

In addition, the state transitions are divided into three types (type A, type B, and type C) according to the change in the lock waiting state. In FIG. 6, the state transition of the type A is indicated by a solid arrow, the state transition of the type B is indicated by a dotted arrow, and the state transition of the type C is indicated by a dashed-dotted arrow.

The state transition of the type A is a state transition to the non-lock waiting state (or the end state of the spinlock operation). In the state transition of the type A, the output control unit 223 generates the output control signal indicating that the trace information is stored in the trace information storage unit 230. Hereinafter, the output control signal indicating that the trace information is stored in the trace information storage unit 230 also referred to as a first output control signal. That is, the output control unit 223 generates the first output control signal in accordance with the spinlock operation state which is in the non-lock waiting state. As a result, the trace information generated in accordance with the state transition of the type A is stored in the trace information storage unit 230.

The state transition of the type B is a state transition to the lock waiting state. In the state transition of the type B, the output control unit 223 generates the output control signal indicating that the trace information is not stored in the trace information storage unit 230. Hereinafter, the output control signal indicating that the trace information is not stored in the trace information storage unit 230 also referred to as a second output control signal. That is, the output control unit 223 generates the second output control signal in accordance with the spinlock operation state which is in the lock waiting state. As a result, the trace information generated in accordance with the state transition of the type B is not stored in the trace information storage unit 230.

The state transition of the type C is a state transition in which the lock waiting state changes. Specifically, the state transition of the type C is a state transition from the state S13 of the lock 2 waiting state to the state S12 of the lock 1 waiting state. In the state transition of the type C, the output control unit 223 generates the second output control signal. That is, the output control unit 223 generates the second output control signal in accordance with the spinlock operation state which is the lock waiting state, As a result, the trace information generated in accordance with the state transition of the type C is not stored in the trace information storage unit 230. This operation is the same as the operation of the state transition of the type B.

However, in the state transition of the type C, the output control unit 223 is different from the state transition of the type B in that the output control unit 223 also generates the output control signal for the trace information before the state transition of the type C. The trace information before the state transition of the type C is the trace information generated in accordance with the state transition to state S13. As shown in FIG. 6, such state transitions exist in two patterns, “state S21 to state S13” and “state S22 to state S13”.

The transition source of the state transition of the type C is the state S13. Since the state transition to the state S13 corresponds to the state transition of the type B, the output control unit 223 generates the output control signal (second output control signal) indicating that the trace information generated in accordance with the state transition to the state S13 is not stored in the trace information storage unit 230 at the timing when the trace information generated in accordance with the state transition to the state S13 is stored in the first buffer 225. However, when the state transition of the type C (the state S13 to state S12) occurs thereafter, the output control unit 223 again generates the output control signal for the trace information generated in accordance with the state transition to the state S13 at the timing when the trace information generated in accordance with the state transition to the state S13 is stored in the second buffers 226.

Specifically, the output control unit 223 newly generates the output control signal (first output control signal) indicating that the trace information generated in accordance with the state transition to the state S13 is stored in the trace information storage unit 230 in the timing when the trace information generated in accordance with the state transition to the state S13 is stored in the second buffer 226. That is, the output control unit 223 changes the output control signal for the trace information generated in accordance with the state transition to the state S13, from the second output control signal to the first output control signal.

In this manner, when determining that the spinlock operation state after the trace information stored in the first buffer 225 is generated is the lock 1 waiting state and the spinlock operation state after the trace information stored in the second buffer 226 is generated is the lock 2 waiting state, the output control unit 223 generates the output control signal indicating that the trace information stored in the first buffer 225 is not stored in the trace information storage unit 230, and the output control signal indicating that the trace information stored in the second buffer 226 is stored in the trace information storage unit 230.

FIG. 7 is a table for explaining changes in the lock waiting variable information and changes in the output control signal in the state transitions shown in FIG. 6. In the horizontal direction of FIG. 7, the transition state of the transition source, the transition state of the transition destination, the type of the state transition, the trace information generated by the trace information generation unit 210, the change of the lock waiting variable information, and the change of the output control signal are shown.

As shown in FIG. 7, when the state transition of the type A occurs, the lock waiting variable information indicating that the spinlock operation state is the non-lock waiting state is stored in the lock waiting state storage unit 227, or the lock waiting variable information indicating that the spinlock operation state is the non-lock waiting state remains stored in the lock waiting state storage unit 227. Further, with respect to the output control signal, the first output control signal is generated, or the first output control signal remains generated. Thus, the trace information generated in accordance with the state transition of the type A is stored in the trace information storage unit 230.

When the state transition of the type B occurs, the lock waiting variable information indicating that the spinlock operation state is the waiting state for acquiring the lock variable 1 or the waiting state for acquiring the lock variable 2 is stored in the lock waiting state storage unit 227, or the lock waiting variable information indicating that the spinlock operation state is the waiting state for acquiring the variable 1 or the waiting state for acquiring the lock variable 2 remains stored in the lock waiting state storage unit 227. Further, with respect to the output control signal, the second output control signal is generated, or the second output control signal remains generated. Thus, the trace information generated in accordance with the state transition of the type B is not stored in the trace information storage unit 230.

When the state transition of the type C occurs, the lock waiting variable information stored in the lock waiting state storage unit 227 is changed from the lock waiting variable information indicating that the spinlock operation state is the waiting state for acquiring the lock variable 2 to the lock waiting variable information indicating that the spinlock operation state is the waiting state for acquiring the lock variable 1. With respect to the output control signal, the second output control signal is generated, and the trace information generated in accordance with the state transition of the type C is not stored in the trace information storage unit 230.

Further, as described above, when the state transition of the type C occurs, the output control signal for the trace information generated in accordance with the immediately preceding state transition is generated (changed) again. As shown in FIG. 7, the output control signal for the trace information generated in accordance with the immediately preceding state transition is changed from the second output control signal to the first output control signal, and the trace information generated in accordance with the immediately preceding state transition is changed so as to be stored in the trace information storage unit 230.

Thus, in the case of the state transition of the type C, there is a possibility that the output control signal changes. However, since the trace buffer 222 is configured by the buffer having the two-stage configuration (first buffer 225 and second buffer 226), there is no problem even when a change in the output control signal occurs. That is, even when changing from the second output control signal to the first output control signal, the trace information is stored in the second buffer 226 and remains without being discarded.

Returning to FIG. 2, the description of the functional blocks of the semiconductor device 100 will be continued. The output control unit 223 is connected to the output unit 224, and outputs the output control signal generated to the output unit 224.

The output unit 224 is connected to the trace buffer 222, the output control unit 223, and the trace information storage unit 230. The output unit 224 determines whether to output the trace information output from the trace buffer 222 to the trace information storage unit 230 based on the output control signal output from the output control unit 223.

For example, when receiving the first output control signal, the output unit 224 outputs the trace information to the trace information storage unit 230. In this case, the trace information storage unit 230 stores the trace information output from the output unit 224.

On the other hand, when receiving the second output control signal, the output unit 224 does not output the trace information to the trace information storage unit 230. That is, the trace information is not stored in the trace information storage unit 230 but is discarded.

Here, a procedure for outputting trace information will be described with reference to specific examples. First, in FIG. 6, it is assumed that the state transitions of the spinlock operation state occur in the order of “state S0, state S11, state S12, state S12, and state S21”. In this case, two loop processing is executed before the PE 110 acquires the lock variable 1. Therefore, the trace information is generated by the trace information generation unit 210 in the order of “trace information 1 (first time), trace information 1 (second time), trace information 1 (third time), and trace information 2 (first time)”. Then, the trace information control unit 220 outputs the trace information to the trace information storage unit 230 in the order of “trace information 1 (first time) and trace information 2 (first time)” by controlling not to store the trace information 1 (second time) and the trace information 1 (third time) in the trace information storage unit 230.

The lock waiting time related to the lock variable 1 in this case can be measured by the difference between the time information included in the trace information 1 (first time) and the time information included in the trace information 2 (first time). As described above, in this case, by discarding the trace information 1 (second time) and the trace information 1 (third time) unnecessary for measuring the lock waiting time related to the lock variable 1, it is possible to reduce the risk of shortage of the storage space for storing the trace information.

Next, in FIG. 6, it is assumed that the state transitions of the spinlock operation state occur in the order of “state S0, state S11, state S21, state S13, state S22, and state S3”. In this case, one loop processing is executed before the PE 110 acquires the lock variable 2. Therefore, the trace information is generated by the trace information generation unit 210 in the order of “trace information 1 (first time), trace information 2 (first time), trace information 1 (second time), trace information 2 (second time), and trace information 3 (first time)”. Then, the trace information control unit 220 outputs the trace information to the trace information storage unit 230 in the order of “trace information 1 (first time), trace information 2 (first time), and trace information 3 (first time)” by controlling not to store the trace information 1 (second time) and the trace information 2 (second time) in the trace information storage unit 230.

The lock waiting time related to the lock variable 2 in this case can be measured by the difference between the time information included in the trace information 2 (first time) and the time information included in the trace information 3 (first time). As described above, in this case, by discarding the trace information 1 (second time) and the trace information 2 (second time) unnecessary for measuring the lock waiting time related to the lock variable 2, it is possible to reduce the risk of shortage of the storage space for storing the trace information.

Finally, in FIG. 6, it is assumed that the state transitions of the spinlock operation state occur in the order of “state S0, state S11, state S21, state S13, state S12, state S21 and state S3”. In this case, the type of the lock waiting state changes. Therefore, the trace information is generated by the trace information generation unit 210 in the order of “trace information 1 (first time), trace information 2 (first time), trace information 1 (second time), trace information 1 (third time), trace information 2 (second time), and trace information 3 (first time)”. Then, the trace information control unit 220 outputs the trace information to the trace information storage unit 230 in the order of “trace information 1 (first time), trace information 2 (first time), trace information 1 (second time), trace information 2 (second time), and trace information 3 (first time)” by controlling not to store the trace information 1 (third time) in the trace information storage unit 230.

The lock waiting time related to the lock variable 1 in this case can be measured by the difference between the time information included in the trace information 1 (first time) and the time information included in the trace information 2 (first time), and the difference between the time information included in the trace information 1 (second time) and the time information included in the trace information 2 (second time). In addition, the lock waiting time related to the lock variable 2 in this case can be measured by the difference between the time information included in the trace information 2 (second time) and the time information included in the trace information 3 (first time). As described above, in this case, by discarding the trace information 1 (third time) unnecessary for measuring the lock waiting time related to the lock variables 1 and 2, it is possible to reduce the risk of shortage of the storage space for storing the trace information.

As described above, the semiconductor device 100 according to the first embodiment discards the trace information unnecessary for measuring of the lock waiting time by the trace information control unit 220, and stores only the trace information necessary for measuring of the lock waiting time in the trace information storage unit 230. As a result, the semiconductor device 100 can efficiently collect trace information while reducing the risk of shortage of the storage space for storing the trace information. Thus, even if the semiconductor device 100 has the spinlock configuration in which there are two or more types of lock variables, the trace information required by the developer of the application can be appropriately acquired.

The trace information generated by the trace information generation unit 210 also includes trace information other than the spinlock trace information. The output control unit 223 refers to the identification information of the trace information stored in the trace buffer 222, and when it is determined that the trace information is trace information other than the spinlock trace information, the output control unit 223 does not perform the above-described control on the spinlock trace information. That is, the output control unit 223 generates a control signal indicating that the trace information is stored in the trace information storage unit 230, so that the trace information other than the spinlock trace information is stored in the trace information storage unit 230 without being discarded by the output unit 224.

### Second Embodiment

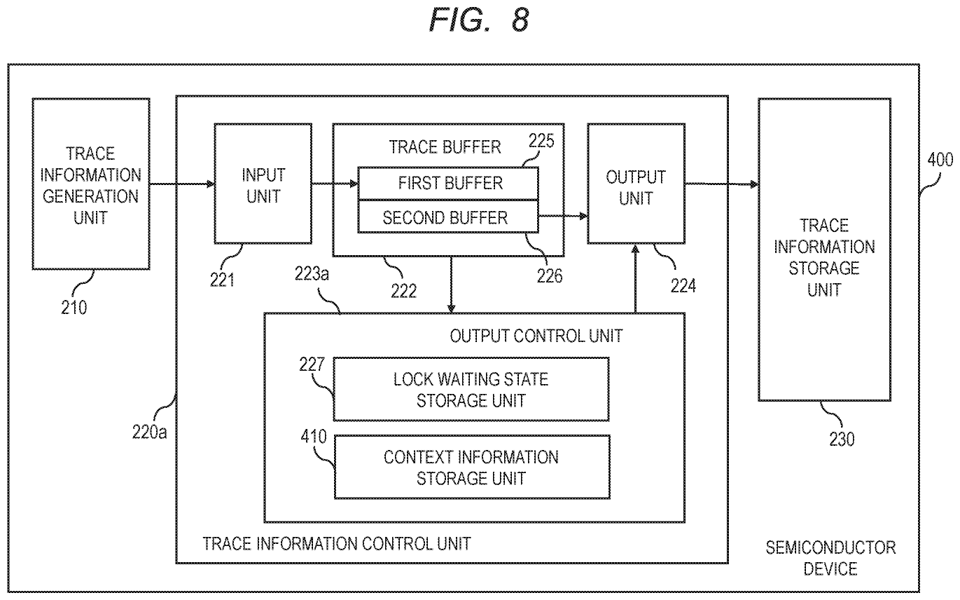

Next, a second embodiment will be described. A semiconductor device 400 according to the second embodiment differs from the semiconductor device 100 according to the first embodiment in that the semiconductor device 400 includes a context information storage unit 410. FIG. 8 is a block diagram showing an example of functional blocks of the semiconductor device 400 according to the second embodiment. Among the configurations shown in FIG. 8, those having the same functions as those in FIG. 2 are denoted by the same reference numerals, and description thereof is omitted.

As shown in FIG. 8, the semiconductor device 400 includes the context information storage unit 410 in addition to the configuration shown in FIG. 2. The context information storage unit 410 is included in an output control unit 223a of a trace information control unit 220a.

The context information storage unit 410 may be configured by an area (e.g., register) for temporarily storing data in the CPU 111 or may be configured by a part of an area of the trace information storage unit 230.

During the spinlock operation, that is, in the situation where the spinlock trace information is stored in the second buffer 226, the output control unit 223a confirms the identification information included in the trace information stored in the first buffer 225 at the timing when the trace information is stored in the first buffer 225.

The output control unit 223a saves the spinlock trace information stored in the second buffer 226 to the context information memory unit 410 if the output control unit 223a determines that the trace information stored in the first buffer 225 is interrupt trace information of an interrupt processing start. That is, the saved spinlock trace information becomes the spinlock trace information generated by the trace information generation unit 210 immediately before the interrupt trace information of the interrupt start is generated.

In addition, the output control unit 223a saves the lock waiting variable information stored in the lock waiting state storage unit 227 to the context information storage unit 410, and stores the lock waiting variable information indicating that the spinlock operation state is the non-lock waiting state in the lock waiting state storage unit 227. That is, the lock waiting variable information stored in the lock waiting state storage unit 227 is held by the save process.

The output control unit 223 generates the output control signal indicating that the interrupt trace information of the interrupt processing start is stored in the trace information storage unit 230 based on the lock waiting variable information indicating that the spinlock operation state is the non-lock waiting state and the interrupt trace information of the interrupt processing start. As a result, the interrupt trace information of the interrupt processing start is stored in the trace information storage unit 230.

Each time new trace information is stored in the first buffer 225, the output control unit 223a confirms the identification information of the stored trace information. when the output control unit 223a confirms interrupt trace information (e.g., the interrupt trace information of the interrupt process end) following the interrupt trace information of the interrupt process start, the output control unit 223a generates the output control signal indicating that the following interrupt trace information is stored in the trace information storage unit 230. That is, the interrupt trace information is stored in the trace information storage unit 230 without being discarded by the output unit 224.

Subsequently, when the output control unit 223a determines that the trace information stored in the first buffer 225 is the spinlock trace information, the output control unit 223a returns the trace information saved in the context information storage unit 410 to the second buffer 226. The output control unit 223a returns the lock waiting variable information saved in the context information storage unit 410 to the lock waiting state storage unit 227. After returning the spinlock trace information and the lock waiting variable information stored in the context information storage unit 410, the output control unit 223a operates in the same manner as the first embodiment.

A procedure for outputting trace information will be described with a specific example. Here, it is assumed that the state transitions of the spinlock operation state and the interrupt processing occur in the order of “state S0, state S11, state S21, state S13, interrupt processing start, interrupt processing end, state S21, and state S3”. In this case, the trace information is generated by the trace information generation unit 210 in the order of “trace information 1 (first time), trace information 2 (first time), trace information 1 (second time), interrupt trace information of interrupt processing start, interrupt trace information of interrupt processing end, trace information 2 (second time), and trace information 3 (first time)”. Then, the trace information control unit 220a outputs the trace information to the trace information storage unit 230 in the order of “trace information 1 (first time), trace information 2 (first time), interrupt trace information of interrupt processing start, interrupt trace information of interrupt processing end, and trace information 3 (first time)” by controlling not to store the trace information 1 (second time) and the trace information 2 (second time) in the trace information storage unit 230.

The lock waiting time related to the lock variable 1 in this case can be measured by the difference between the time information included in the trace information 1 (first time) and the time information included in the trace information 2 (first time). In addition, the lock waiting time related to the lock variable 2 in this case can be measured by the difference between the time information included in the trace information 2 (first time) and the time information included in the trace information 3 (first time). As described above, in this case, even when the interrupt processing occurs during the spinlock operation, the trace information 1 (second time) and the trace information 2 (second time) unnecessary for measuring the lock waiting time related to the lock variables 1 and 2 can be discarded.

When the lock waiting time related to the lock variable 2 is measured based on the difference between the time information included in the trace information 2 (first time) and the time information included in the trace information 3 (first time), the measured time includes the interrupt time due to the interrupt processing. However, since the interrupt trace information of the interrupt processing start and the interrupt trace information of the interrupt processing end are stored in the trace information storage unit 230, it is possible to measure the interrupt time due to the interrupt processing by the difference between the time information included in the interrupt trace information of the interrupt processing start and the time information included in the interrupt trace information of the interrupt processing end. That is, by subtracting the difference between the time information included in the interrupt trace information of the interrupt processing start and the time information included in the interrupt trace information of the interrupt processing end from the difference between the time information included in the trace information 2 (first time) and the time information included in the trace information 3 (first time), it is possible to measure the lock waiting time related to the lock variable 2 more accurately.

### Third Embodiment

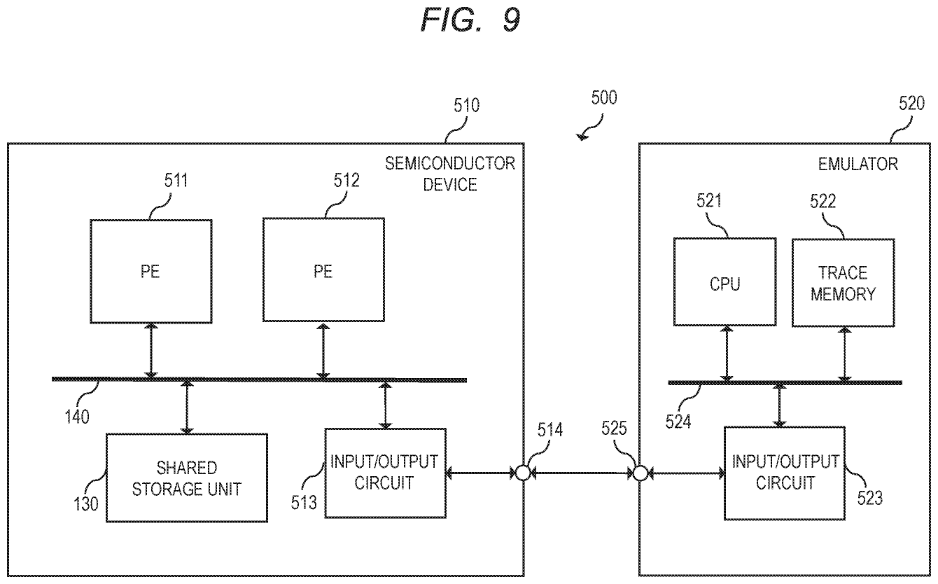

Next, a third embodiment will be described. FIG. 9 is a block diagram showing an example of a hardware configuration of a debug system 500 according to the third embodiment. As shown in FIG. 9, the debug system 500 includes a semiconductor device 510 and an emulator 520.

The semiconductor device 510 includes a PE 511, a PE 512, the bus 140, the shared storage unit 130, an input/output circuit 513, and an external terminal 514. The semiconductor device 510 differs from the semiconductor device 100 shown in FIG. 1 in that the semiconductor device 510 includes the input/output circuit 513 and the external terminal 514. Further, the PE 511 and the PE 512 differ from the PE 110 and the PE 120 shown in FIG. 1 in that each of the PE 511 and the PE512 does not have the function of the trace information control unit 220 shown in FIG. 2.

The PE 511 and the PE 512 outputs trace information. That is, the PE 511 and the PE 512 have the function of the trace information generation unit 210 shown in FIG. 2. The trace information output from the PE 511 and the PE 512 is transmitted to the input/output circuit 513 via the bus 140.

The input/output circuit 513 is connected to the bus 140 and the external terminal 514. In addition, the external terminal 514 is connected to the emulator 520. The input/output circuit 513 outputs the trace information transmitted from the PE 511 and the PE 512 to the emulator 520 via the external terminal 514.

The emulator 520 includes a CPU 521, a trace memory 522, an input/output circuit 523, a bus 524, and an external terminal 525. The external terminal 525 is connected to the external terminal 514 of the semiconductor device 510. The emulator 520 receives the trace information from the semiconductor device 510 via the external terminal 525. The received trace information is stored in the trace memory 522. Further, the emulator 520 outputs a break signal to the semiconductor device 510 via the external terminal 525.

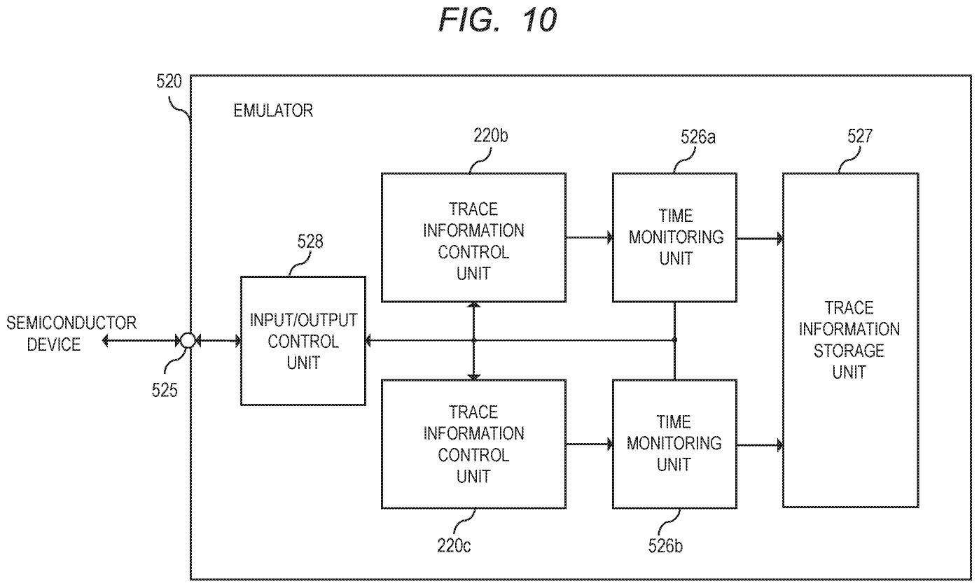

FIG. 10 is a block diagram showing an example of functional blocks of the emulator 520 according to the third embodiment. As shown in FIG. 10, the emulator 520 includes a trace information control unit 220b, a trace information control unit 220c, a time monitoring unit 526a, a time monitoring unit 526b, a trace information storage unit 527, and an input/output control unit 528.

The functions of the trace information control unit 220b, the trace information control unit 220c, the time monitoring unit 526a, and the time monitoring unit 526b can be realized by the CPU 521 executing a program stored in the trace memory 522. The function of the input/output control unit 528 can be realized by the input/output circuit 523. The trace information storage unit 527 may be configured by a part of an area of the trace memory 522.

The trace information control units 220b and 220c have the same configuration and function as the trace information control unit 220 shown in FIG. 2 or FIG. 8. The trace information control unit 220b is connected to the input/output control unit 528. The trace information control unit 220b receives the trace information output from the PE 511 of the semiconductor device 510 via the input/output control unit 528. In addition, the trace information control unit 220c is connected to the input/output control unit 528. The trace information control unit 220c receives the trace information output from the PE 512 of the semiconductor device 510 via the input/output control unit 528.

The time monitoring unit 526a is connected to the trace information control unit 220b, the trace information storage unit 527, and the input/output control unit 528. The time monitoring unit 526a receives the trace information output from the trace information control unit 220b. The time monitoring unit 526a outputs the received trace information to the trace information storage unit 524.

In addition, the time monitoring unit 526a measures the difference between the time information included in the two pieces of trace information output from the trace information control unit 220b. The time monitoring unit 526a compares the measured difference between the time information with a threshold value. The time monitoring unit 526a generates the break signal when the time monitoring unit 526a determines that the measured difference between the time information exceeds the threshold value. The time monitoring unit 526a outputs the generated break signal to the PE 511 of the semiconductor device 510 via the input/output control unit 528.

When the PE 511 receives the break signal output from the time monitoring unit 526a, the PE 511 stops the operation of the processing unit (CPU).

The time monitoring unit 526b is connected to the trace information control unit 220c, the trace information storage unit 527, and the input/output control unit 528. The time monitoring unit 526b has the same configuration and function as the time monitoring unit 526a. That is, the time monitoring unit 526b outputs the trace information received from the trace information control unit 220c to the trace information storage unit 527, and outputs the break signal to the PE 512 of the semiconductor device 510 via the input/output control unit 528.

When the PE 512 receives the break signal output from the time monitoring unit 526b, the PE 512 stops the operation of the processing unit (CPU).

In this manner, the trace information control unit 220b and the time monitoring unit 526a operate in accordance with the trace information output from the PE 511. On the other hand, the trace information control unit 220c and the time monitoring unit 526b operate in accordance with the trace information output from the PE 512.

The trace information storage unit 527 is connected to the time monitoring unit 526a and the time monitoring unit 526b. The trace information storage unit 527 stores the trace information output from the time monitoring unit 526a and the time monitoring unit 526b.

As described above, according to the third embodiment, the CPUs of the PE 511 and the PE 512 stop working by the break signals output from the time monitoring unit 526a and the time monitoring unit 526b. That is, since the emulator 520 can output the break signal at a timing at which the lock waiting time exceeds a predetermined threshold value, the trace information at the timing at which the cause occurs is reliably stored in the trace information storage unit 527. In addition, since the data of the timing when the cause occurred is stored in the registers and the internal storage units of the PE 511 and the PE 512, the cause can be identified more easily.

On the other hand, for example, in the semiconductor device 100 according to the first embodiment, when the developer of the application wants to identify the cause of the lock waiting time exceeding the threshold vale, the developer of the application needs to stop the operation of the CPUs of the PE 110 and the PE 120 at any timing and analyze the trace information stored in the trace information storage unit 230. However, when the capacity of the trace information storage unit 230 is insufficient, there is a possibility that the trace information at the timing when the cause occurs is not stored in the trace information storage unit 230. In this case, it takes time to identify the cause.

Although the invention made by the present inventors has been specifically described based on the embodiments, it is needless to say that the present invention is not limited to the above-described embodiments, and various changes may be made without departing from the scope thereof.

What is claimed is:

1. A semiconductor device comprising:
a first processor element; and
a second processor element,
wherein the semiconductor device is configured to perform exclusive control between the first processor element and the second processor element using a spinlock,
wherein each of the first processor element and the second processor element comprises:
storage unit configured to store a program;
a processing unit configured to the program, and
wherein, by executing the program, the processing unit is configured to:
generate first spinlock trace information and second spinlock trace information following the first spinlock trace information;
determine, based on a first spinlock operation state after the first spinlock trace information is generated and the second spinlock trace information, a second spinlock operation state after the second spinlock trace information is generated; and
generate an output control signal for determining whether to store the second spinlock trace information in the storage unit in accordance with the second spinlock operation state.

2. The semiconductor device according to claim 1,
wherein lock waiting variable information indicating that the first spinlock operation state is a waiting state for acquiring a lock variable is stored in the storage unit if the first spinlock operation state is the waiting state for acquiring the lock variable,
wherein the lock waiting variable information indicating that the first spinlock operation state is not the waiting state for acquiring the lock variable is stored in the storage unit if the first spinlock operation state is not the waiting state for acquiring the lock variable, and
wherein, by executing the program, the processing unit is configured to specify the first spinlock operation state based on the lock waiting variable information stored in the storage unit.

3. The semiconductor device according to claim 2, wherein, by executing the program, the processing unit is configured to store the lock waiting variable information indicating that the first spinlock operation state is not the waiting state for acquiring the lock variable in the storage unit if the first spinlock trace information is spinlock trace information for starting acquiring the lock variable.

4. The semiconductor device according to claim 2, wherein, by executing the program, the processing unit is configured to store the lock waiting variable information indicating that the second spinlock operation state is the waiting state for acquiring the lock variable in the storage unit if that the second spinlock operation state is the waiting state for acquiring the lock variable is determined.

5. The semiconductor device according to claim 4,
wherein, by executing the program, the processing unit is configured to:
generate interrupt trace information of an interrupt processing start immediately after generating the first spinlock trace information; and
generate interrupt trace information of an interrupt processing end immediately before generating the second spinlock trace information,
wherein the interrupt trace information of the interrupt processing start and the interrupt trace information of the interrupt processing end are stored in the storage unit, and
wherein the lock waiting variable information related to the first spinlock operation state is held in the storage unit until the second spin lock operation state is determined.

6. The semiconductor device according to claim 2,
wherein the spinlock comprises a configuration of a spinlock including a first lock variable and a second lock variable,
wherein the lock waiting variable information indicating that the first spinlock operation state is a waiting state for acquiring the first lock variable is stored in the storage unit if the first spinlock operation state is the waiting state for acquiring the first lock variable, and
wherein the lock waiting variable information indicating that the first spinlock operation state is a waiting state for acquiring the second lock variable is stored in the storage unit if the first spinlock operation state is the waiting state for acquiring the second lock variable.

7. The semiconductor device according to claim 6, wherein, by executing the program, the processing unit is configured to:
store the lock waiting variable information indicating that the second spinlock operation state is the waiting state for acquiring the first lock variable in the storage unit if that the second spinlock operation state is the waiting state for acquiring the first lock variable is determined, and
store the lock waiting variable information indicating that the second spinlock operation state is the waiting state for acquiring the second lock variable in the storage unit if that the second spinlock operation state is the waiting state for acquiring the second lock variable is determined

8. The semiconductor device according to claim 7, wherein, by executing the program, the processing unit is configured to generate the output control signal indicating that the first spinlock trace information is not stored in the storage unit and the output control signal indicating that the second spinlock trace information is stored in the storage unit if the first spinlock operation state is the waiting state for acquiring the first lock variable and the second spinlock operation state is the waiting state for acquiring the second lock variable.

9. The semiconductor device according to claim 1, wherein the first spinlock trace information and the second spinlock trace information are continuous spinlock trace information.

10. The semiconductor device according to claim 1, wherein, by executing the program, the processing unit is configured to generate a plurality of spinlock trace information including the first spinlock trace information and the second spinlock trace information at a timing of starting acquiring the lock variable, at a timing of succeeding in acquiring the lock variable, and at a timing of failing to acquire the lock variable.

11. The semiconductor device according to claim 10, wherein each of the plurality of spinlock trace information includes identification information indicating one of an event which acquisition processing of the lock variable has started, an event which an acquisition of the lock variable has succeeded and an event which the acquisition of the lock variable has failed, and time information indicating a time at which the event indicated by the identification information has occurred.

12. The semiconductor device according to claim 1,
wherein, by executing the program, the processing unit is configured to generate the output control signal indicating that the second spinlock trace information is stored in the storage unit if that the second spinlock operation state is not the waiting state for acquiring the lock variable is determined, and
wherein the second spinlock trace information is stored in the storage unit based on the output control signal indicating that the second spinlock trace information is stored in the storage unit.

13. The semiconductor device according to claim 1,
wherein, by executing the program, the processing unit is configured to generate the output control signal indicating that the second spinlock trace information is not stored in the storage unit if that the second spinlock operation state is the waiting state for acquiring the lock variable is determined, and
wherein the second spinlock trace information is discarded based on the output control signal indicating that the second spinlock trace information is not stored in the storage unit.

14. A control method of a semiconductor device which performs exclusive control between a first processor element and a second processor element using a spinlock, each of the first processor element and the second processor element including a storage unit which stores a program, and a processing unit which causes the semiconductor device to perform the control method by executing the program, the control method of the semiconductor device comprising:
generating first spinlock trace information and second spinlock trace information following the first spinlock trace information;
determining, based on a first spinlock operation state after the first spinlock trace information is generated and the second spinlock trace information, a second spinlock operation state after the second spinlock trace information is generated; and
generating an output control signal for determining whether to store the second spinlock trace information in the storage unit in accordance with the second spinlock operation state.

15. The control method of the semiconductor device according to claim 14, further comprising:
generating the output control signal indicating that the second spinlock trace information is stored in the storage unit if that the second spinlock operation state is not the waiting state for acquiring the lock variable is determined, and
storing the second spinlock trace information in the storage unit based on the output control signal indicating that the second spinlock trace information is stored in the storage unit.

16. The control method of the semiconductor device according to claim 14, further comprising:
generating the output control signal indicating that the second spinlock trace information is not stored in the storage unit if that the second spinlock operation state is the waiting state for acquiring the lock variable is determined, and
discarding the second spinlock trace information based on the output control signal indicating that the second spinlock trace information is not stored in the storage unit.
